(19) United States
(12) Patent Application Publication
(10) Pub. No.: US 2011/0098146 A1
(43) Pub. Date: Apr. 28, 2011

(54) Drive Chain

(76) Inventor: Sherwin Ghaffarkhan, Boulder, CO (US)

(21) Appl. No.: 12/604,016

(22) Filed: Oct. 22, 2009

(51) Int. Cl. F16G 13/07

(52) U.S. Cl. 474/233

(57) ABSTRACT

A single link and chain having the single link wherein the link includes two opposing side link members, each side link member having a first pin receiving surface one a first end and a second pin receiving surface on a second end, wherein the side link members are integrally connected by a cross link member, wherein the side link members are maintained in opposing relation such that the respective first pin receiving surfaces are coaxially aligned with one another and second pin receiving surfaces are coaxially aligned with one another.

### BACKGROUND OF INVENTION

1. Field of Invention

This invention relates to endless power transmission chains for transmitting rotational power between sprockets, and more particularly, but not by way of limitation, to a chain for power or manual operated cycles.

2. Prior Art

A typical chain comprises rows of link plates interconnected by transverse pins in a closed loop. Conventional link plates typically are generally flat and have an hour glass shape and are separated by rollers and connected by pins usually two in number. Teeth of a sprocket are received between the rollers and link plates.

Various versions of chains have been proposed heretofore. For example, some have mixed link plates shapes irregularly along the length of the chain to disperse the points at which meshing noises are generated, and reduce the overall noise generated by the chain by virtue of the mutual interference of individually generated noises. Other designs enhance functionality of chains.

The prior chains have been various cycles and perform their intended function in simply moving gears and sprockets. In the case of extreme sports, such chains have not been found adequate for cycles which undergo significant acrobatic maneuvers. For example, certain maneuvers subject the chain and sprockets/gears to extreme force such as when a bicycle chain may be run along a cement or steel surface wherein the chain's slidability and grindability are observed in such circumstances.

It is desirable to provide a cycle chain with enhance stability for extreme conditions as well as improved aesthetic appearance. The instant invention overcomes these deficiencies of the prior art.

### SUMMARY OF INVENTION

An object of the invention is to improve chains.

It is another object to protect a sprocket ring and teeth thereof through an improved chain.

It is still another object to enhance strength of a chain.

A further object is to provide chain with enhanced slidability.

Another object is to provide chain with enhanced grindability.

Yet another object is to enhance chain life.

Another object of the invention is to reduce noise produced by operation of a chain.

A further object is to aid in preventing debris from entering chain.

In accordance with the invention, the present invention is directed to an improvement in a chain. The improvement includes a single link which includes two opposing side link members, each side link member having a first pin receiving surface in a first end and a second pin receiving surface in a second end, wherein the side link members are integrally connected by a cross link member such that the side link members and the cross member are a single piece, wherein the side link members are maintained in opposing relation such that the respective first pin receiving surfaces are coaxially aligned with one another and second pin receiving surfaces are coaxially aligned with one another. The first ends are laterally spaced from each other to receive a roller bearing in proximate contact therebetween, the roller bearing having a pin receiving surface which is coaxially aligned with other pin receiving surfaces of the first ends when the roller bearing is received therebetween. The second ends are laterally spaced from each other to receive first ends of a complementary formed single link proximate therebetween such that pin receiving surfaces of the complementary formed single link coaxially align with pin receiving surfaces of the second ends when received therebetween. In a preferred embodiment, a tapered section extends from the cross link member and over an area formed between the second ends and the first ends. The side link members can include first ends in generally parallel relation to one another and second ends in generally parallel relation to one another and wherein first ends are inwardly disposed relative to outwardly disposed second ends. In other words, the first ends are laterally spaced from one another a distance lesser than the second ends are from each other. The inwardly disposed first ends interconnect to outwardly disposed second ends via angle members.

In another embodiment, multiple like formed single links are interconnected to form a closed loop chain for connection of two or more sprockets in driving relationship. In this embodiment, the first ends of a first single link are disposed inside second ends of a second single link and a roller bearing is disposed between the first ends with pin receiving surfaces coaxially aligned. A retaining pin is operably disposed into the coaxially aligned pin receiving surfaces. Each single link of the chain is connected in this regard to provide meshing surfaces adapted to engage teeth of a sprocket.

An outer edge of the side link members can include a continuous curved surface composed of a concave circular arc having a radius of curvature approximately equal to the radius of curvature of a sprocket tooth at a meshing point, and a convex circular arc having a radius of curvature such that the convex arc is positioned to interfere slightly with the sprocket teeth which it engages. The center of curvature of the convex arc is situated on the dedendum side of the pitch line relative to the chain.

Further objects, details and advantages of the invention will be apparent from the following detailed description, when read in conjunction with the drawings.

### BRIEF DESCRIPTION OF THE DRAWINGS

FIG. 1 is an isometric view of a single link of the invention.

FIG. 2 is a side view of FIG. 1.

FIG. 3 is a top view of FIG. 1.

FIG. 4 is a plan view of the link of FIG. 1 in an unfolded and preformed manner.

FIG. 5 is an isometric view of a chain having a plurality of single links of the invention.

FIG. 6 is a top view of FIG. 5.

FIG. 7 is a side view of FIG. 6.

FIG. 8 is a perspective of a roller bearing of the invention.

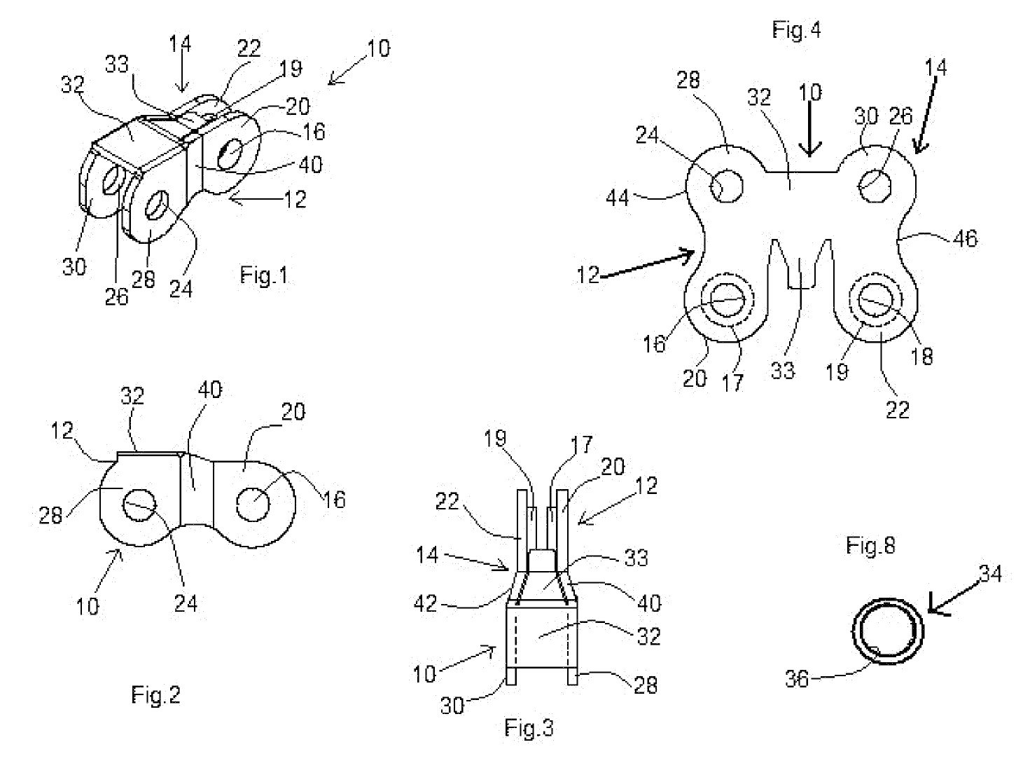

### DETAILED DESCRIPTION OF PREFERRED EMBODIMENT

Referring now to the drawings, a single chain link of the instant invention is generally designated by the numeral 10. The single chain link 10 includes two opposing side link members 12 and 14. Each side link member 12 and 14 has a first pin receiving surface 16 and 18, respectively, in a first end 20 and 22, respectively, and a second pin receiving surface 24 and 26 in a second end 28 and 30, respectively. First pin receiving surfaces 16 and 18 terminate within a respective collar 17 and 19 which extend inwardly from side members 12 and 14. The first ends 20 and 22 are integrally connected by a cross link member 32, wherein the side link members 12 and 14 are maintained in opposing relation such that the respective first pin receiving surfaces 16 and 18, respectively, are coaxially aligned with one another and second pin receiving surfaces 24 and 26, respectively, are coaxially aligned with one another.

The first ends 20 and 22 are laterally spaced from each other to receive a roller bearing 34 in proximate contact therebetween onto respective collars 17 and 19. As seen in FIGS. 5-7, the chain 100 includes multiple like formed single links 10, roller bearings 34 and pins 38. The roller bearing 34 has an inner race 36 proximate about and in contact with collars 17 and 19 also serving as a pin receiving surface which can be coaxially aligned with other pin receiving surfaces 16 and 18 of the first ends 20 and 22, respectively, when the roller bearing 34 is received therebetween. The second ends 28 and 30 of a first single link 10A are laterally spaced from each other to receive first ends 20 and 22 of a complementary formed single link 10B proximate therebetween such that pin receiving surfaces 16 and 18 of the complementary formed single link 10B coaxially align with pin receiving surfaces 24 and 26, respectively, of the second ends 28 and 30, respectively, of link 10A when received therebetween.

In the preferred embodiment, a tapered section 33 extends from the cross link member 32 and over an area formed between the second ends 28 and 30 and the first ends 20 and 22. The side link members 12 and 14 can preferably include first ends 20 and 22, respectively, in generally parallel relation to one another and second ends 28 and 30, respectively, in generally parallel relation to one another and wherein first ends 20 and 22 are inwardly disposed relative to outwardly disposed second ends 28 and 30, respectively. In other words, the first ends 20 and 22 are laterally spaced from one another a distance lesser than the second ends 28 and 30 are from each other. The inwardly disposed first ends 20 and 22 interconnect to outwardly disposed second ends 28 and 30, respectively, via angle members 40 and 42, respectively.

Multiple single links 10 can be interconnected to form a closed loop chain for connection of two or more sprockets in driving relationship. In this case, the first ends 20 and 22 of a single link 10B are disposed inside second ends 28 and 30 of a single link 10A and a roller bearing 34 is disposed between the first ends 20 and 22 with pin receiving surfaces 16, 18, 24, 26 coaxially aligned. Retaining pin 38 is operably disposed into the coaxially aligned pin receiving surfaces 16, 18, 24, 26. Each single link 10 of the chain 100 is connected in this regard to provide meshing surfaces adapted to engage teeth of a sprocket.

An outer edge 44 and 46 of the side link members 12 and 14, respectively, can include a continuous curved surface composed of a concave circular arc having a radius of curvature approximately equal to the radius of curvature of a sprocket tooth at a meshing point, and a convex circular arc having a radius of curvature such that the convex arc is positioned to interfere slightly with the sprocket teeth which it engages. The center of curvature of the convex arc is situated on the dedendum side of the pitch line relative to the chain 100.

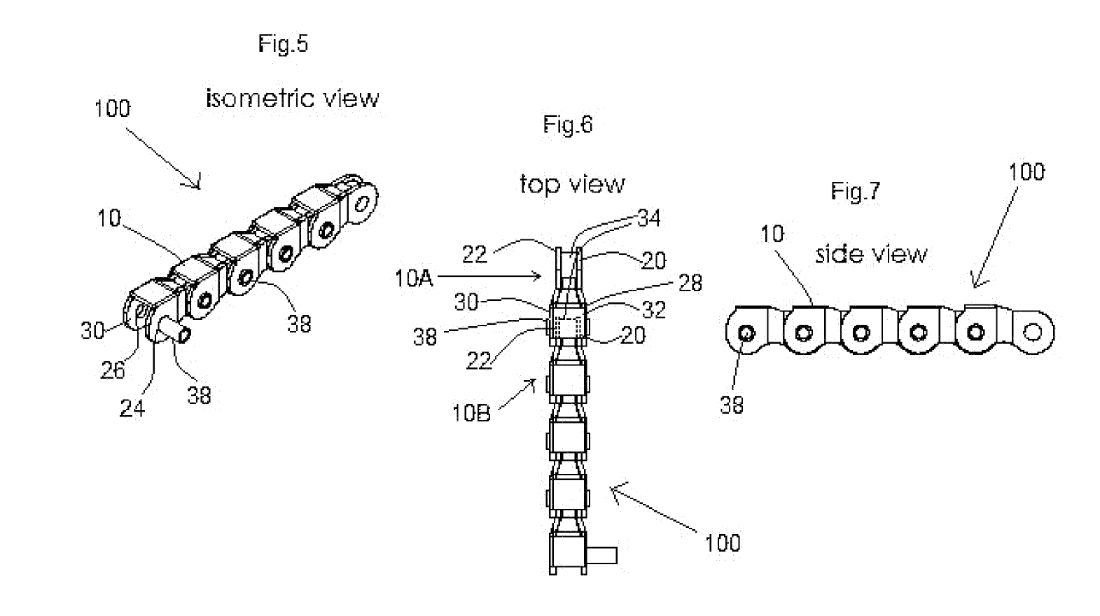

FIG. 4 depicts the single link 10 in a plan generally flat state prior to forming and generally appears in a butterfly shape. The single link 10 can be stamped to form the shape depicted in the remaining figures. By way of example, there are gaps formed between the tapered section 33 and side members 12 and 14 which provide for the angle members 40 and 42 to form along the tapered section 33 and form a partial upper enclosure. Once ends 20 and 22 are connected with roller bearing 34 operably disposed about collars 17 and 19, they are disposed adjacent within second ends 28 and 30 of an adjacent link 10. Then, an outer section of the chain 100 is substantially enclosed as seen in the top view of FIG. 6. This protects the teeth of the sprocket as well as the sprocket ring. The unique configuration of the chain 100 and links 10 provide for a sleek and strong chain which is less susceptible to break during the rigors of use. This is particularly true in bike racing, wherein “slidability” and “grindability” are terms used to describe the action under which the chain is subjected. Here, the instant invention provides for an improved link 10 and chain 100 which not only enhanced look, but also enhance operation and longevity of the chain and components to which it is part. The links 10, roller bearings 34 and pins 38 can be formed of a stainless steel to provide a resilient structure. It is contemplated that some other alloy or suitably strong material may also be employed to make the invention. The link 10 can preferably be an integral component.

While the present invention has been set forth above in a preferred embodiment, it is contemplated that other modifications, improvements and derivations will be readily apparent to those skilled in the art. Accordingly, the appended claims hereto should be accorded the full scope of protection of any such modifications, improvements and derivations.

What is claimed is:

1. An improvement in a chain, wherein the improvement includes a single link which includes two opposing side link members, each side link member having a first pin receiving surface in a first end and a second pin receiving surface in a second end, wherein said side link members are integrally connected by a cross link member such that said side link members and said cross member are a single piece, wherein said side link members are maintained in opposing relation such that said respective first pin receiving surfaces are coaxially aligned with one another and said second pin receiving surfaces are coaxially aligned with one another, and wherein said first ends are inwardly disposed relative to said second ends.

2. The improvement in a chain of claim 1, wherein said first ends are in generally parallel relation to one another and said second ends in generally parallel relation to one another.

3. The improvement in a chain of claim 1, wherein each said inwardly disposed first end interconnects to said outwardly disposed second end by an angle member.

4. The improvement in a chain of claim 1, wherein said second ends are integrally connected by said cross link member at an edge of each said second end.

5. The improvement in a chain of claim 4, wherein said side link members are rigidly maintained by virtue of being integrally formed with said cross link member.

6. The improvement in a chain of claim 1, wherein said first ends each include a collar extending therefrom through which said first pin receiving surface extends.

7. The improvement in a chain of claim 6, wherein said first ends are laterally spaced from each other to receive a roller bearing having an inner race proximate about said collars, said inner race providing a pin receiving surface which is coaxially aligned with other said pin receiving surfaces of said first ends when said roller bearing is received therebetween.

8. The improvement in a chain of claim 1, wherein said first ends are laterally spaced from each other to receive a roller bearing proximate therebetween, said roller bearing having a pin receiving surface which is coaxially aligned with other said pin receiving surfaces of said first ends when said roller bearing is received therebetween.

9. The improvement in a chain of claim 1, wherein said second ends are laterally spaced from each other to receive first ends of a complementary formed single link in proximate contact therebetween such that pin receiving surfaces of the complementary formed single link coaxially align with pin receiving surfaces of the second ends when received therebetween.

10. The improvement in a chain of claim 1, which includes a tapered section extending from said cross link member and over an area formed between said second ends and said first ends.

11. The improvement in a chain of claim 1, wherein each said side link member includes an outer edge having a continuous curved surface composed of a concave circular arc having a radius of curvature approximately equal to the radius of curvature of a sprocket tooth at a meshing point, and a convex circular arc having a radius of curvature such that the convex arc is positioned to interfere slightly with the sprocket teeth which it engages.

12. A chain, which includes:
a plurality of single links, wherein each single link includes two opposing side link members, each side link member having a first pin receiving surface in a first end and a second pin receiving surface in a second end, wherein said side link members are integrally connected by a cross link member such that said side link members and said cross member are a single piece, wherein said side link members are maintained in opposing relation such that said respective first pin receiving surfaces are coaxially aligned with one another and said second pin receiving surfaces are coaxially aligned with one another, and wherein said first ends are inwardly disposed relative to said second ends.

13. The chain of claim 12, wherein said first ends are in generally parallel relation to one another and said second ends in generally parallel relation to one another.

14. The chain of claim 12, wherein each said inwardly disposed first end interconnects to said outwardly disposed second end by an angle member.

15. The chain of claim 12, wherein said second ends are integrally connected by said cross link member at an edge of each said second end.

16. The chain of claim 15, wherein said side link members are rigidly maintained by virtue of being integrally formed with said cross link member.

17. The chain of claim 12, wherein said first ends each include a collar extending therefrom through which said first pin receiving surface extends.

18. The chain of claim 12, wherein said first ends are laterally spaced from each other to receive a roller bearing having an inner race proximate about said collars, said inner race providing a pin receiving surface which is coaxially aligned with other said pin receiving surfaces of said first ends when said roller bearing is received therebetween.

19. The chain of claim 12, wherein said first ends are laterally spaced from each other to receive a roller bearing proximate therebetween, said roller bearing having a pin receiving surface which is coaxially aligned with other said pin receiving surfaces of said first ends when said roller bearing is received therebetween.

20. The chain of claim 12, wherein said second ends are laterally spaced from each other to receive first ends of a complementary formed single link proximate therebetween such that pin receiving surfaces of the complementary formed single link coaxially align with pin receiving surfaces of the second ends when received therebetween.

21. The chain of claim 12, which includes a tapered section extending from said cross link member and over an area formed between said second ends and said first ends.

22. The chain of claim 12, wherein each said side link member includes an outer edge having a continuous curved surface composed of a concave circular arc having a radius of curvature approximately equal to the radius of curvature of a sprocket tooth at a meshing point, and a convex circular arc having a radius of curvature such that the convex arc is positioned to interfere slightly with the sprocket teeth which it engages.

23. The chain of claim 12, which includes a retaining pin operably disposed into each said coaxially aligned pin receiving surfaces of said first ends and said second ends.

24. The chain of claim 12, which includes a plurality of said single links interconnected to form a closed loop chain for connection to a sprocket.
